(19) United States
(12) Patent Application Publication
(10) Pub. No.: US 2025/0187518 A1
(43) Pub. Date: Jun. 12, 2025

(54) WINDOW INSERT CONDIMENT HOLDER

(71) Applicant: Milkmen Design, LLC, Richfield, OH (US)

(72) Inventors: Michael KOURY, Medina, OH (US); William MOUJAES, Akron, OH (US); Tony LAHOOD, Hinckley, OH (US); Cory PRESCOTT, Sagamore Hills, OH (US)

(73) Assignee: Milkmen Design, LLC, Richfield, OH (US)

(21) Appl. No.: 18/932,678

(22) Filed: Oct. 31, 2024

Related U.S. Application Data
(63) Continuation-in-part of application No. 29/919,733, filed on Dec. 6, 2023.

(51) Int. Cl. B60N 3/10

(52) U.S. Cl. CPC B60N 3/103

(57) ABSTRACT

A window insert for retaining a condiment container to allow for the condiment container to be used while seated in vehicle. The window insert has an insertion portion adapted to be inserting into a gap defined between a door panel and a window of a vehicle. The window insert also has a support portion extending outwardly from the insertion portion where the support portion is adapted to be located adjacent to the window when the insertion portion is inserted into the gap. The window insert further includes a receiver portion provided on the support portion where the receiver position is adapted to support the condiment container. The window insert has a limiter region extending outwardly from a front surface which is opposite a rear surface. The limiter region extends outwardly from the front surface for a distance and is located a distance vertically below the receiver portion.

### REFERENCE TO RELATED APPLICATIONS

This application is a Continuation-in-Part of U.S. Design application Ser. No. 29/919,733, filed on Dec. 6, 2023; the disclosure of which is incorporated herein by reference.

### TECHNICAL FIELD

The present application is generally directed to holding devices. More particularly, this application relates to a device suitable for holding condiment containers provided by fast-food restaurants or for receiving condiments provided by fast-food restaurants. Specifically, the application is directed to a condiment holder engageable between a window and a door panel of a vehicle.

### BACKGROUND ART

People frequently travel and stop at fast-food restaurants to obtain food. While fast-food restaurants typically provide an area for customers to eat their food, many people elect to obtain their food through a drive-through and eat in their vehicles. Fast-food meals are frequently accompanied by a variety of condiments, such as ketchup or other dipping sauces that come in small flexible pouches or rigid containers. Dispensing condiments from a flexible pouch can be quite messy since the pouches have to be torn open and the condiment squeezed out of the pouch and over the french fries, chicken nuggets, or other food as desired. Rigid condiment containers are less messy to use than pouches but the consumer must hold the container in their hand or must place the container somewhere on the food packaging or in their vehicle during use.

One solution offered by the prior art is the provision of a holder which is engageable with an automobile vent. These air vent engaged holders are configured to receive a rigid condiment container therein. The holders retain the condiment container in a desired orientation for access to condiment provided in the condiment container.

While the above-referenced condiment container holders work really well, the consumer has to be seated in the vehicle in a location where they have easy and direct access to an air vent. If the consumer is, for example, seated in a back seat where they do not have ready access to an air vent, that consumer must resort, once again, to holding the condiment container in their hand or balancing the condiment container on the legs or lap or on the car seat.

### SUMMARY OF THE INVENTION

The condiment holder disclosed herein provides a solution for consumers who do not have direct access to a vehicle air vent and therefore cannot utilize one of the aforementioned patented condiment holders.

In one aspect, an exemplary embodiment of the present disclosure may provide a window insert for retaining a condiment container comprising an insertion portion adapted to be inserted into a gap defined between a door panel and a window of a vehicle, a support portion extending outwardly from the insertion portion, said support portion being adapted to be located adjacent the window when the insertion portion is inserted into the gap, and a receiver portion provided on the support portion, said receiver portion being adapted to support the condiment container.

In another aspect, an exemplary embodiment of the present disclosure may provide where the window insert further comprises a front surface and a rear surface opposite one another and a limiter region extending outwardly from the front surface for a distance. In another aspect, an exemplary embodiment of the present disclosure may provide where the limiter region is located a distance vertically below the receiver portion. In another aspect, an exemplary embodiment of the present disclosure may provide where the insertion portion comprises a first region originating at a bottom of the window insert, a second region extending upwardly from the first region, and where a back surface of the second region is arranged at a first angle relative to a back surface of the first region. In another aspect, an exemplary embodiment of the present disclosure may provide where the first angle is less than 180 degrees. In another aspect, an exemplary embodiment of the present disclosure may provide where the first region tapers in width moving in a direction from the second region to the bottom of the window insert. In another aspect, an exemplary embodiment of the present disclosure may provide where the insertion portion further comprises a third region extending upwardly from the second region and where a back surface of the third region is arranged at a second angle relative to the back surface of the second region. In another aspect, an exemplary embodiment of the present disclosure may provide where the second region is greater than 180 degrees. In another aspect, an exemplary embodiment of the present disclosure may provide where the insertion portion further comprises a fourth region extending between the second portion and the third region of the insertion portion and where a back surface of the fourth region is arranged at a third angle relative to the back surface of the third region. In another aspect, an exemplary embodiment of the present disclosure may provide where the third angel is greater than 180 degrees. In another aspect, an exemplary embodiment of the present disclosure may provide further comprising an aperture defined in the insertion portion and wherein the aperture extends between a front and a back surface of the window insert. In another aspect, an exemplary embodiment of the present disclosure may provide further comprising at least one strengthening rib provided on the insertion portion and where the at least one strengthening rib is formed on a back surface of the window insert. In another aspect, an exemplary embodiment of the present disclosure may provide further comprising at least one strengthening rib provided on a front surface of the window insert and where the at least one strengthening extends between a part of the insertion portion and a part of the support portion. In another aspect, an exemplary embodiment of the present disclosure may provide where the support portion comprises a front surface and a back surface opposite one another, a perimeter wall extending outwardly beyond the front surface, and where the receiver portion is defined by a portion of the perimeter wall. In another aspect, an exemplary embodiment of the present disclosure may provide where the perimeter wall comprising a first planar region and a second planar region opposed to one another and where the first planar region and the second planar region taper in depth moving in a direction from a top of the window insert toward the insertion portion. In another aspect, an exemplary embodiment of the present disclosure may provide where the first and second planar region comprise a limiter region of the window insert. In another aspect, an exemplary embodiment of the present disclosure may provide where the support portion extending upwardly from the insertion portion and is an inverted V-shape. In another aspect, an exemplary embodiment of the present disclosure may provide where the support portion comprises a top end and a bottom end opposite one another, a left side and a right side extending between the top and bottom ends, and wherein the bottom end is arcuate in shape. In another aspect, an exemplary embodiment of the present disclosure may provide further comprising a shelf extending beyond a front surface of the support portion and where the shelf comprises a limiter region of the window insert. In another aspect, an exemplary embodiment of the present disclosure may provide where the receiver portion is bendable relative to a lowermost section of the support portion. In another aspect, an exemplary embodiment of the present disclosure may provide further comprising a first wing and a second wing extending beyond a first side and a second side of the receiver portion respectively. In another aspect, an exemplary embodiment of the present disclosure may provide where each one of the first and second wings is foldable relative to the receiver portion. In another aspect, an exemplary embodiment of the present disclosure may provide further comprising a tab extending outwardly from each the first and second wings, an insert defined in the lowermost section of the support portion, and where the tab is frictionally engaged with the insert when the first and second wings are folded relative to the receiver portion. In another aspect, an exemplary embodiment of the present disclosure may provide further comprising an aperture defined in the receiver portion, where the aperture extends between a front surface and a back surface of the receiver portion, and where the aperture is adapted to receive the condiment container therein. In another aspect, an exemplary embodiment of the present disclosure may provide where the aperture is complementary to the condiment container to be received therein.

In one aspect, an exemplary embodiment of the present disclosure may provide a method for presenting condiments for use while seated in a vehicle, said method comprising providing a condiment container holding a volume of condiment therein, providing a window insert, inserting an insertion portion of the window insert into a gap between a vehicle door panel and a weather strip of the vehicle window on a vehicle door, extending a support portion of the window insert outwardly from the gap, positioning the support portion adjacent to the vehicle window, and engaging the condiment container with a receiver portion of the support portion of the window insert.

In another aspect, and exemplary embodiment of the present disclosure may provide where engaging the condiment container with the receiver portion comprising providing a condiment holder, fastening the condiment holder to the receiver portion, and inserting the condiment container into the condiment holder. In another aspect, and exemplary embodiment of the present disclosure may provide where inserting the condiment container into the condiment holder further comprising inserting the condiment container into an aperture defined by the condiment holder. In another aspect, and exemplary embodiment of the present disclosure may provide where engaging the condiment container with the receiver portion further comprising inserting the condiment container into an aperture defined by the receiver portion.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is an environmental view of a first embodiment of a window insert in accordance with the present disclosure shown installed between a window and a door panel of a vehicle door, and showing a condiment holder engaged with the window insert and a condiment container received in the condiment holder.

FIG. 2 (FIG. 2) is a front, top, left side isometric view of the first embodiment of the window insert in accordance with the present disclosure shown in isolation.

FIG. 3 (FIG. 3) is a rear, top, left side isometric view of the first embodiment of the window insert.

FIG. 4 (FIG. 4) is a front elevation view of the first embodiment of the window insert.

FIG. 5 (FIG. 5) is a cross section of the window insert taken along line 5-5 of FIG. 4.

FIG. 6 (FIG. 6) is an operational view showing the first embodiment of the window insert being installed on the vehicle door, and showing the condiment holder and the condiment container readied for engagement with the window insert.

FIG. 7 (FIG. 7) is a partial, enlarged cross-section of the top of the first embodiment of the window insert showing a condiment holder engaged therewith.

FIG. 8 (FIG. 8) is a front, top, left side isometric view of a second embodiment of a window insert in accordance with the present disclosure.

FIG. 9 (FIG. 9) is a rear, top, left side isometric view of the second embodiment of the window insert.

FIG. 10 (FIG. 10) is a front elevation view of the second embodiment of the window insert.

FIG. 11 (FIG. 11) is a rear elevation view of the second embodiment of the window insert.

FIG. 12 (FIG. 12) is a cross section of the window insert taken along line 12-12 of FIG. 10.

FIG. 13 (FIG. 13) is a partial, enlarged front, top, left side isometric view of the second embodiment of the window insert shown with a condiment holder installed therein.

FIG. 14 (FIG. 14) is a front, top, left side isometric view of a blank for assembling a third embodiment of a window insert in accordance with the present disclosure.

FIG. 15 (FIG. 15) is a rear, top, left side isometric view of the blank for the third embodiment of the window insert shown in FIG. 14.

FIG. 16 (FIG. 16) is a front elevation view of the blank for the third embodiment of the window insert.

FIG. 17 (FIG. 11) is a front, top, left side isometric view of the blank for the window insert of FIG. 15 being folded and assembled for use.

FIG. 18 (FIG. 18) is a cross-section of the third embodiment of the window insert in the folded and assembled configuration shown in FIG. 17.

Similar numbers refer to similar parts throughout the drawings.

### DETAILED DESCRIPTION

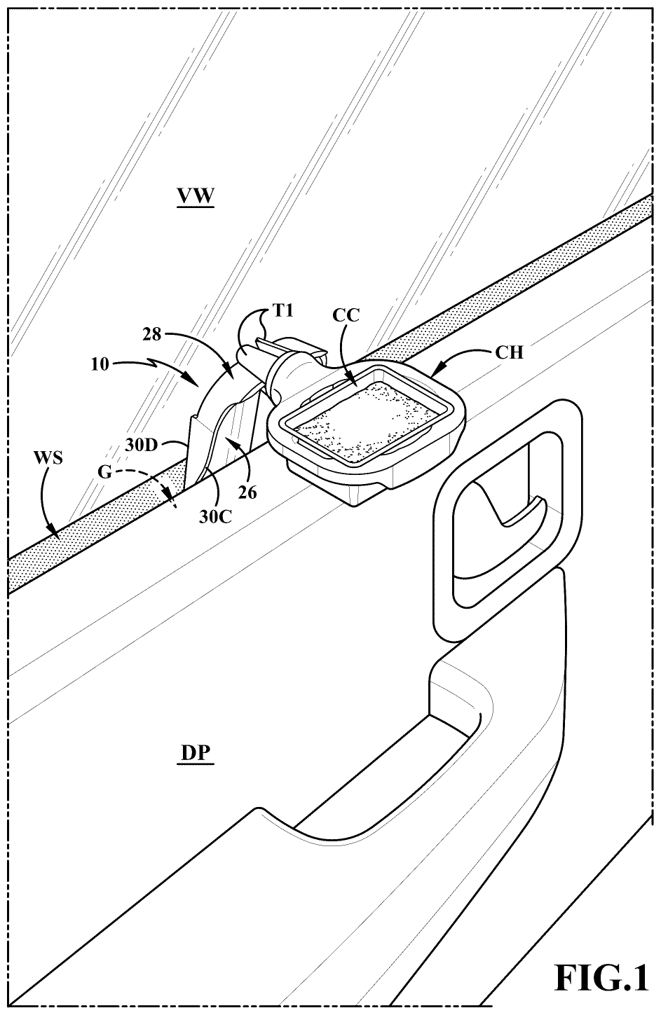

Referring to FIGS. 1-7, there is shown a first embodiment of a window insert in accordance with the present disclosure, generally indicated at 10. Window insert 10, as illustrated in FIG. 1, is configured to be engaged between a vehicle door panel “DP” and a weather strip “WS” of a vehicle window “VW” on a vehicle door. Window insert 10 as illustrated is a unibody design. The window insert is a unibody in that the component is integrally extruded, molded, printed, or additively manufactured, removably machines, or formed as a single, unitary, monolithic member. Window insert 10 is fabricated from a relatively rigid, manmade material. In one example, polymer composite materials may be utilized to form a substantial majority of all of the component parts or elements of window insert 10. The polymer composite materials are integrally formed, molded, printed, or extruded to form window insert 10. Window insert 10 is configured to withstand typical user handling of placing the window insert 10 between the vehicle window “VW” and door panel “DP”, and then utilizing window insert 10 to hold and support condiment holder “CH” and of placing and using a condiment container “CC” within the condiment holder “CH”, and then using the same. The materials and construction of window insert 10 are such that window insert 10 is not readily damaged during installation and use. While it is contemplated that window insert 10 is uniformly and integrally extruded, molded, printed or otherwise formed, it should be understood that in other instances the components or elements of the window insert 10 may be formed separately and then be suitably assembled. Additionally, it will be understood that window insert 10 may be formed from materials other than polymer composite materials. In another example, the window insert 10 may be formed using a semi-rigid elastomeric material or a rubber material configured to withstand deformation upon impact or bending by the user. Any suitable material is contemplated to fabricate window insert 10. Furthermore, while the components or elements of the window insert 10 are discussed below individually, it is to be clearly understood that the components and their corresponding reference elements are respective components or elements of the unitary window insert 10.

Condiment holder “CH”, as illustrated in FIG. 1, is substantially identical to condiment holder shown and described in U.S. Pat. No. 10,967,776 (Koury et al.) entitled “Condiment Holder”; U.S. Pat. No. 11,518,287 (Moujaes et al.) entitled “Rotatable Condiment Holder”; U.S. Design Pat. No. D960,653 (Moujaes et al.) entitled “Condiment Holder”; U.S. Design Pat. No. D960,654 (Moujaes et al.) entitled “Condiment Holder”; U.S. Design Pat. No. D899,196 (Moujaes et al.) entitled “Condiment Holder”; and U.S. patent application Ser. No. 17/992,991 (Koury et al.) entitled “Rotatable Condiment Holder” the entire disclosures of which are incorporated herein by reference. It will be understood, however, that any suitable configuration of condiment holder other than condiment holder “CH” may be operatively engaged with and be supported by window insert 10.

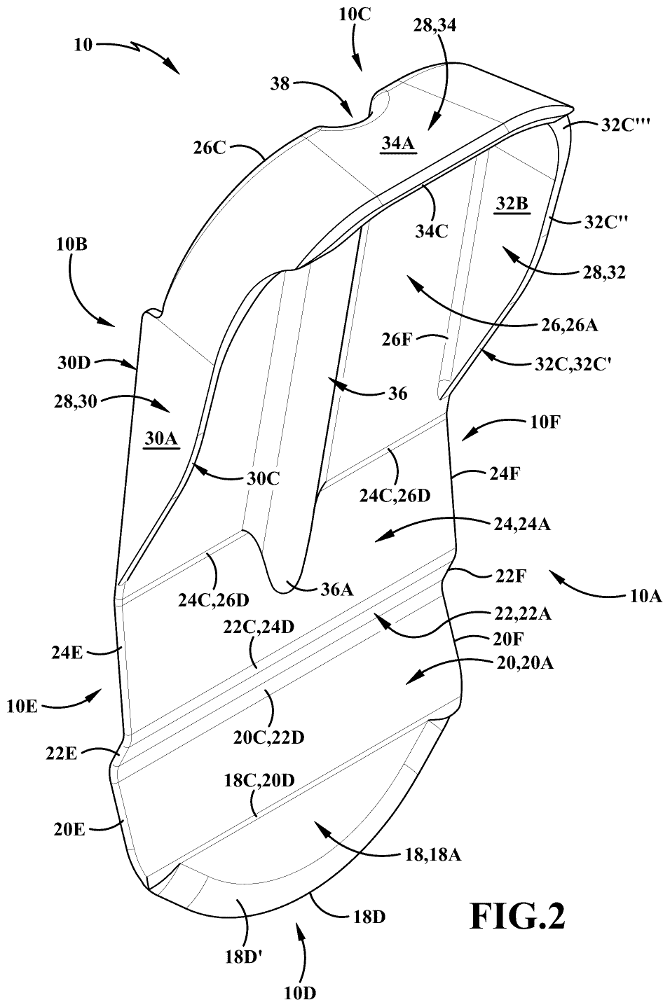

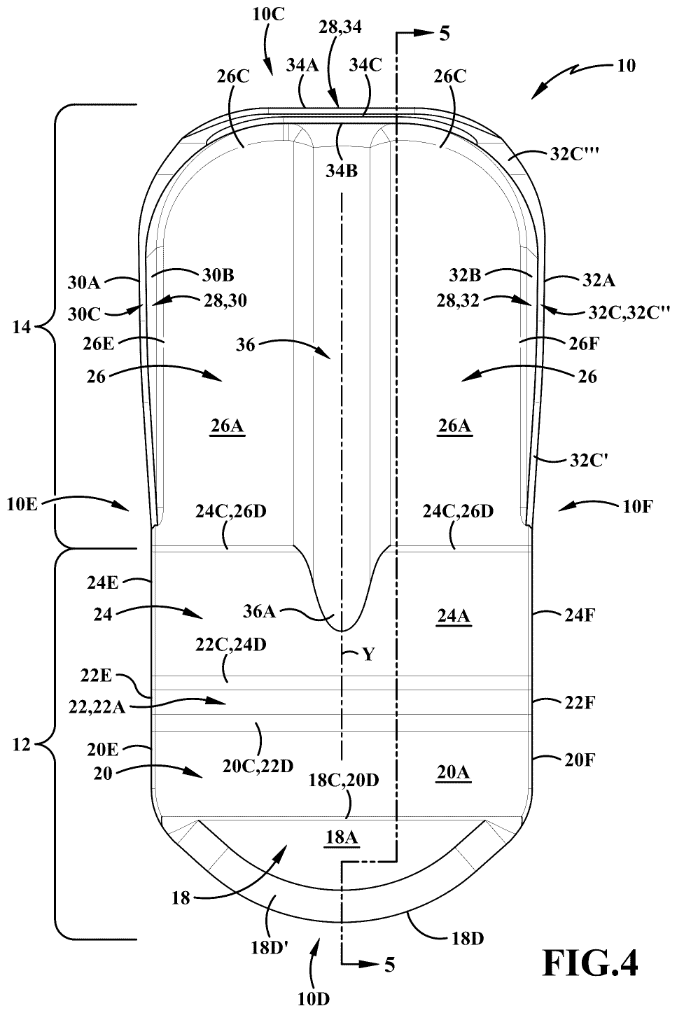

Window insert 10 generally includes a front 10A (see FIG. 2) and a rear 10B (see FIG. 2) opposite one another. When window insert 10 is installed in a vehicle door as shown in FIG. 1, front 10A is oriented so as to face the vehicle door panel “DP” and the rear 10B is oriented so as to face the vehicle window “VW”. Window insert 10 further includes top end 10C (see FIG. 2) and a bottom end 10D (see FIG. 2) opposite one another and defining an uppermost and a lowermost limit of window insert 10 respectively. Window insert 10 further includes a left side 10E and a right side 10F opposite one another. Window insert 10 has an imaginary longitudinal axis “Y” (FIG. 4) which extends from top end 10C to bottom end 10D of window insert 10. Window insert 10 is symmetrical about a midline (not numbered) running through longitudinal axis “Y”.

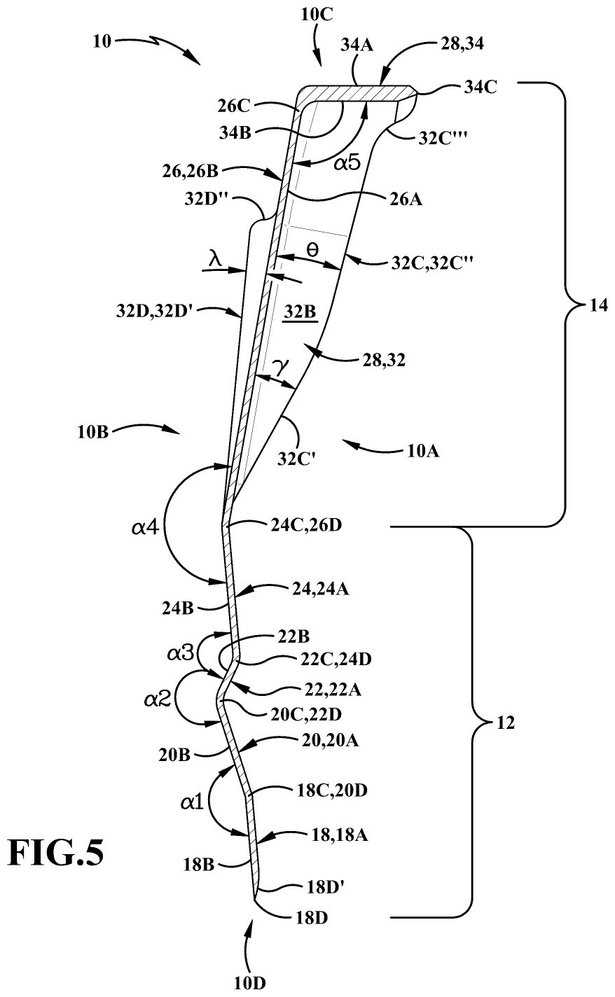

As best seen in FIGS. 4 and 5, window insert 10 includes an insertion portion 12 and a support portion 14. Insertion portion 12 extends upwardly from bottom end 10D towards top end 10C. Support portion 14 extends between top end 10C and insertion portion 12. Insertion portion 12 of the window insert 10 is configured to be received between vehicle door panel “DP” and weather strip “WS” of vehicle window “VW”. Support portion 14 of the window insert 10 is configured to extend upwardly and outwardly from the weather strip “WS” and door panel “DP” and is positioned in front of an inner surface of the vehicle window “VW” and within a gap “G” defined between the weather strip “WS” and door panel “DP”. Support portion 14 is oriented so as to receive and secure a condiment holder “CH” thereto as will be later described herein.

Referring now to FIGS. 2-5, insertion portion 12 of window insert 10 comprises a first region 18, a second region 20, a third region 22, and a fourth region 24. First region 18 comprises a lowermost region of window insert 10. Second region 20 extends upwardly and outwardly from first region 18. Third region 22 extends upwardly and outwardly from second region 20. Fourth region 24 extends upwardly and outwardly from third region 22. Fourth region 24 extends between third region 22 and support portion 14 of window insert 10.

First region 18 has a front surface 18A and a back surface 18B which are opposed to one another. First region 18 has a top 18C which is contiguous with and transitions into second region 20. Front surface 18A and back surface 18B meet along an arcuate edge 18D which comprises the bottom end 10D of window insert 10. The arcuate edge 18D, as illustrated in the attached figures, is convex in shape.

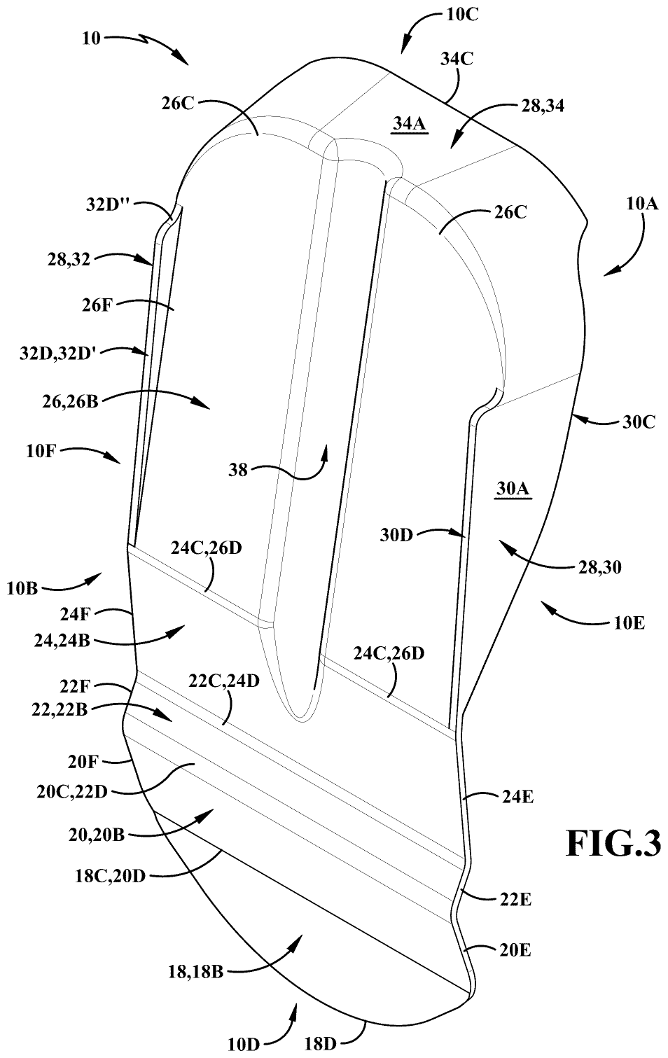

Arcuate edge 18D on front surface 18A is tapered. The taper is indicated by reference number 18D′ in FIGS. 3, 5, and 6. first region 18 When insert 10 is viewed from the front (as in FIG. 4), first region 18 is generally semi-circular in configuration.

The second region 20 of insertion portion 12 has a generally rectangular configuration as shown in FIG. 4. Second region 20 extends between top 18C of first region 18 and third region 22. Second region 20 has a front surface 20A and a back surface 20B which are opposed to one another, a top 20C and a bottom 20D which are opposed to one another, and a left side 20E and right side 20F which are opposed to one another. Top 20C and bottom 20D are generally parallel with one another and left and right sides 20E, 20F are generally parallel with one another. Bottom 20D of second region 20 is continuous with top 18C of first region. Second region 20 is located vertically above first region 18.

First region 18 and second region 20 are arranged at a first angle “α1” relative to one another. In particular, the back surface 18B of first region 18 and the back surface 20B of second region 20 are arranged at the first angle “α1” relative to one another. This can best be seen in FIGS. 3 and 5. First angle “α1” is less than 180°. A first bend is formed between the first and second regions 18, 20. The first bend extends along top 18C and bottom 20D of first and second regions 18, 20, respectively. The first bend is convex when insert 10 is viewed from the front. In one embodiment, first angle “α1” is between 150-180 degrees. More specifically, first angle “α1” is between 160-170 degrees. Most specifically, first angle “α1” is about 167 degrees.

As indicated earlier herein, insertion portion 12 further includes third region 22, generally depicted as having a rectangular configuration. Third region 22 has a front surface 22A and a back surface 22B which are opposed to one another, a top 22C and a bottom 22D which are opposed to one another, and a left side 22E and a right side 22F which are opposed to one another. The bottom 22D of third region 22 is continuous with the top 20C of second region 20. The left side 22E is vertically aligned with and continuous with left side 20E of second region 20. Similarly, the right side 22F is vertically aligned with and continuous with right side 20F of second region 20. Top 22C and bottom 22D are generally parallel with one another and left and right sides 22E, 22F are generally parallel with one another. Third region 22 is located vertically above second region 20. The back surface 22B of third region 22 and the back surface 20B of second region 20 are oriented at a second angle “α2” (FIG. 5) relative to one another. The second angle “α2” is greater than 180°. As a consequence, the bottom 22D of third region 22 and top 20C of second region 20 form a second bend in insertion portion 12 that is concave when window insert 10 is viewed from the front. In one embodiment, second angle “α2” is between 210-228 degrees. More specifically, second angle “α2” is between 220-230 degrees. Most specifically, second angle “α2” is about 223 degrees.

As indicated earlier herein, insertion portion 12 further includes fourth region 24, generally depicted as having a rectangular configuration. Fourth region 24 has a front surface 24A and a back surface 24B which are opposed to one another, a top 24C and a bottom 24D which are opposed to one another, and a left side 24E and a right side 24F which are opposed to one another. The bottom 24D of fourth region 24 is continuous with the top 22C of third region 22. The left side 24E is vertically aligned with and continuous with left side 22E of third region 22. Similarly, the right side 24F is vertically aligned with and continuous with right side 22F of third region 22. Top 24C and bottom 24D are generally parallel with one another and left and right sides 24E, 24F are generally parallel with one another. Fourth region 24 is located vertically above third region 22. The back surface 24B of fourth region 24 and the back surface 22B of third region 22 are oriented at a third angle “α3” (FIGS. 3 and 5) relative to one another. The third angle “α3” is less than 180°. As a consequence, the bottom 24D of fourth region 24 and top 22C of third region 22 form a third bend in insertion portion 12 that is convex when insert 10 is viewed from the front. In one embodiment, third angle “α3” is between 135-165 degrees. More specifically, third angle “α3” is between 145-155 degrees. Most specifically, third angle “α3” is about 150 degrees.

It will be understood that although second region 20, third region 22, and fourth region 24 are illustrated herein as being generally rectangular in configuration, these regions may, alternatively, be of any desired shape suitable to be inserted in between the weather strip “WS” and door panel “DP” of the vehicle door.

Support portion 14 includes a panel 26 extending between top end 10C of window insert 10 and fourth region 24 of insertion portion 12. Panel 26 is located vertically above fourth region 24. Panel 26 has a front surface 26A and a back surface 26B (FIG. 3) which are opposed to one another, a top 26C (FIG. 4) a bottom 26D which are opposed to one another, and a left side 26E and a right side 26F which are opposed to one another. Panel 26 is located vertically above fourth region 24 of insertion portion 12 and bottom 26D of panel 26 is substantially continuous with top 24C of fourth region 24. As best seen in FIGS. 3 and 5, back surface 26B of panel 26 is arranged at a fourth angle “α4” relative to back surface 24B of fourth region 24. The fourth angle “α4” is greater than 180°. Consequently, a fourth bend is formed in insert 10 along the top 24C of fourth region 24 and bottom 26D of panel 26. The fourth bend is concave when insert 10 is viewed from the front. In one embodiment, fourth angle “α4” is between 180-210 degrees. More specifically, fourth angle “α4” is between 190-200 degrees. Most specifically, fourth angle “α4” is about 195 degrees.

Support portion 14 includes a perimeter wall 28 extending outwardly and forwardly from the outer edges of front surface 26A of panel 26. Perimeter wall 28 includes a first planar region 30, a second planar region 32, and a third planar region 34. First planar region 30 extends outwardly from left side 26E of panel 26 and second planar region 32 extends outwardly from right side 26F of panel 26. The third planar region 34 extends outwardly from top 26C of panel 26 and extends between first planar region 30 and second planar region 32.

It will be understood that first and second planar regions 30, 32 are substantially identical to one another other than in their orientation relative to front surface 26A of panel 26. The following description of second planar region 32 should be understood to apply equally to first planar region 30.

Second planar region 32 includes an outer surface 32A (see FIG. 4) and an inner surface 32B opposite one another and defining a thickness of second planar region 32 Second planar region 32 includes an edge 32C (see FIG. 5). Edge 32C includes a first section 32C′, a second section 32C″, and a third section 32C″. First section 32C′ of edge 32C extends outwardly from front surface 26A of panel 26 at an angle “γ”. Second section 32C″ extends upwardly from first section 32C′ and is oriented at an angle “θ” relative to front surface 26A of panel 26. Third section 32C′″ extends upwardly and outwardly from second section 32C″ and connects to third planar region 34. Third section 32C″ is arcuate.

In one embodiment, angle “γ” is between 5-35 degrees. More specifically, angle “γ” is between 15-25 degrees. Most specifically, angle “γ” is about 19 degrees. In one embodiment, angle “θ” is between 0-10 degrees. More specifically, angle “θ” is between 2.5-7.5 degrees. Most specifically, angle “θ” is about 4.5 degrees.

Third planar region 34 includes an outer surface 34A and an inner surface 34B (FIG. 5) opposite one another and defining a thickness of third planar region 34. Third planar region 34 includes an edge 34C which is substantially continuous with edges 30C and 32C of first and second planar regions 30, 32. The edge 34C of third planar region 34 defines a beveled lip. Third planar region 34 may be considered a receiver portion configured to receive and support a condiment holder “CH” and thereby a condiment container “CC” thereto.

As best seen in FIG. 3, a part of each of the first planar region 30 and second planar region 32 extends outwardly for a distance beyond rear surface 26B of panel 26. The parts of first planar region 30 and second planar region 32 which extend beyond rear surface 26B comprise wedge-shaped projections 30D, 32D. The wedge-shaped projections 30D, 32D are generally V-shaped and taper in width relative to rear surface 26B moving in a direction from top 10C of insert 10 towards the bottom 10D thereof. In other words, the projections 30D, 32D are widest proximate third planar region 34 and narrowest proximate fourth region 24.

It will be understood that first and second projections 30D, 32D are substantially identical to one another other than in their orientation relative to back surface 26B of panel 26. Referring mainly to FIG. 5, the following description of second projection 32D should be understood to apply equally to first projection 30D.

Second projection 32D includes a rear edge 32D′ extending outwardly from rear surface 2B of panel 26 at an angle “>”. Second projection 32D extends upwardly from fourth region 24 and towards top end 10C of window insert 10. A top edge 32D″ of second projection 32D is located a distance vertically lower than third planar region 34. In other words, second projection 32D does not extend along the whole length of second planar region 32 but rather terminates a distance away from where second planar region 32 intersects third planar region 34. When window insert 10 is installed, the rear edge 32D′ may contact the surface of the vehicle window “VW” (see FIG. 1). As best seen in FIGS. 2 and 3, a strengthening rib 36 is provided in window insert 10. Rib 36 forms a convex projection which extends outwardly from front surface 26A of panel 26 and into front surface 24A of fourth region 24. In particular, the rib 36 originates in third planar region 34 and terminates approximately midway between the top 24C and bottom 24D of fourth region 24. Rib 36 is molded or otherwise formed in the material of window insert 10 such that a concave channel 38 is defined in back surface 26B of panel 26 and back surface 24B of fourth region 24. The lowermost area of rib 36 is generally V-shaped as is indicated by reference number 36A shown in FIG. 4. Rib 36 is configured to provide support to window insert 10 and to reinforce window insert 10 to prevent bending or misshaping of window insert 10 with the use of condiment holder “CH”. In one embodiment, angle “X” is between 0-10 degrees. More specifically, angle “λ” is between 2.5-7.5 degrees. Most specifically, angle “λ” is about 4.5 degrees.

First planar region 30, second planar region 32, first projection 30D, and second projection 32D together form a limiter region (not numbered). The limiter region is configured to be received within the gap “G” defined between the weather strip “WS” and door panel “DP” and prevent the window insert 10 from falling into the door.

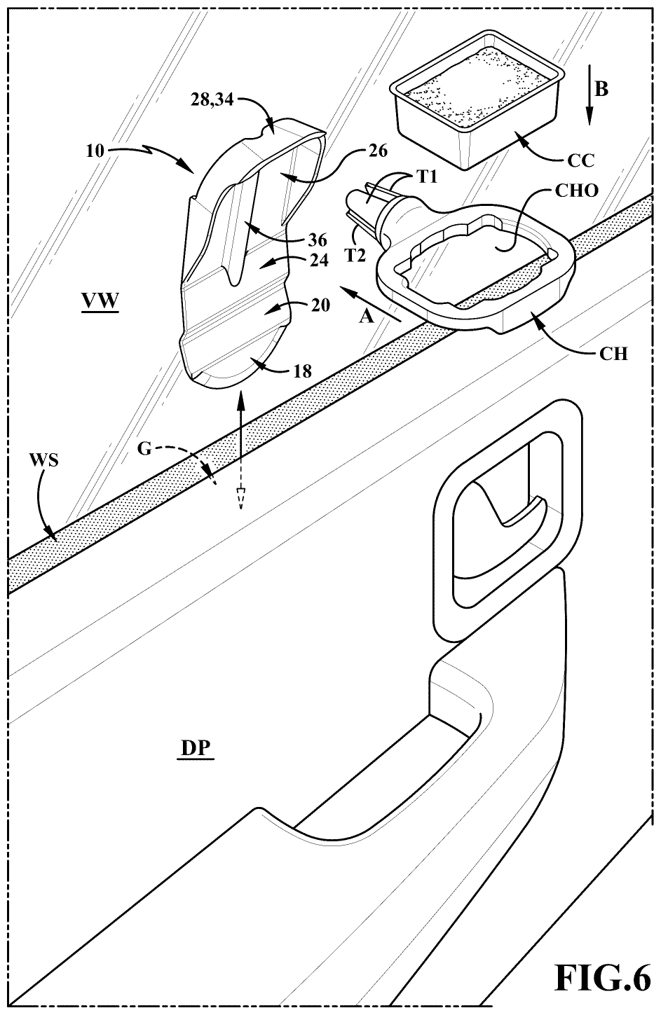

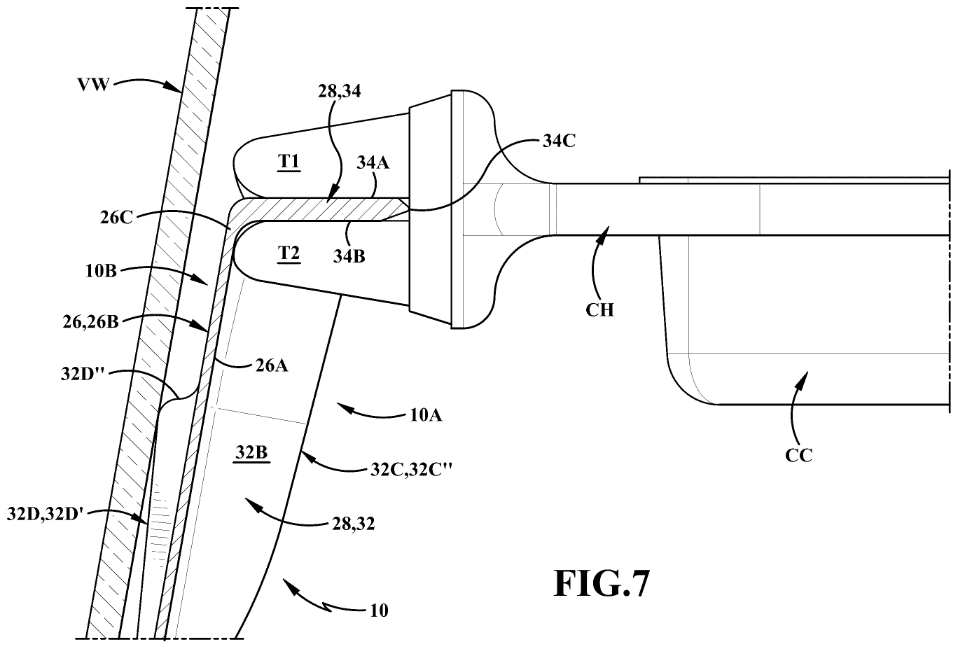

The use of window insert 10 will now be described with reference particularly to FIGS. 6 and 7. It will be understood that the insertion portion 12 of insert 10 may be inserted between weather strip “WS” and door panel “DP” before engagement of condiment holder “CH” with insert 10 or after engagement of condiment holder “CH” with insert 10. Referring now to FIG. 7, the connection between condiment holder “CH” and support portion 14 will be described in more detail. Condiment holder “CH” is configured to be received and supported by the perimeter wall 28. Specifically, condiment holder “CH” is operatively engaged with third planar region 34 of insert 10, Condiment holder “CH” includes a plurality of tines “T” which are operatively engaged with third planar region 34 of insert 10. The tines “T” includes a pair of first tines “T1” and pair of second tines “T2” that are spaced a distance vertically apart from one another. The first tines “T1” and second tines “T2” may be coated in rubber or some other friction enhancing material. The distance between the first and second times “T1”, “T2” is substantially complementary to the thickness of third planar region 34 of perimeter wall 28 of support portion 14. Condiment holder “CH” is positioned such that the gap between the pairs of first tines “T1” and second tines “T2” is horizontally aligned with the third planar region 34 of insert 10. The condiment holder “CH” is moved in a direction “A” (FIG. 6) to cause the first and second tines “T1”, “T2” to slide over the beveled lip 34C of third planar region 34 so that first tines “T1” engage the outer surface 34A of third planar region 34 and second tines “T2” engage the inner surface 34B of third planar region 34 as shown in FIG. 7 The condiment holder “CH” is moved in the direction of arrow “A” until the outer tips of second tines “T2” contact the front surface 26A of panel 26. This is shown in FIG. 7.

At this point, condiment holder “CH” is ready for engagement of condiment container “CC” therewith. As shown in FIG. 6, condiment container “CC” is moved in the direction of arrow “B” and is frictionally engaged in the condiment holder opening “CHO” defined by condiment holder “CH”. The insert 10 is then in condition for a user to easily access the condiment within condiment container “CC”.

When it is no longer desired to use window insert 10, the user will simply grasp support section 14 and slide the insertion portion 12 upwardly and out from the space defined between weather strip “WS” and door panel “CP”. The window insert 10 is contemplated to be able to be used more than once.

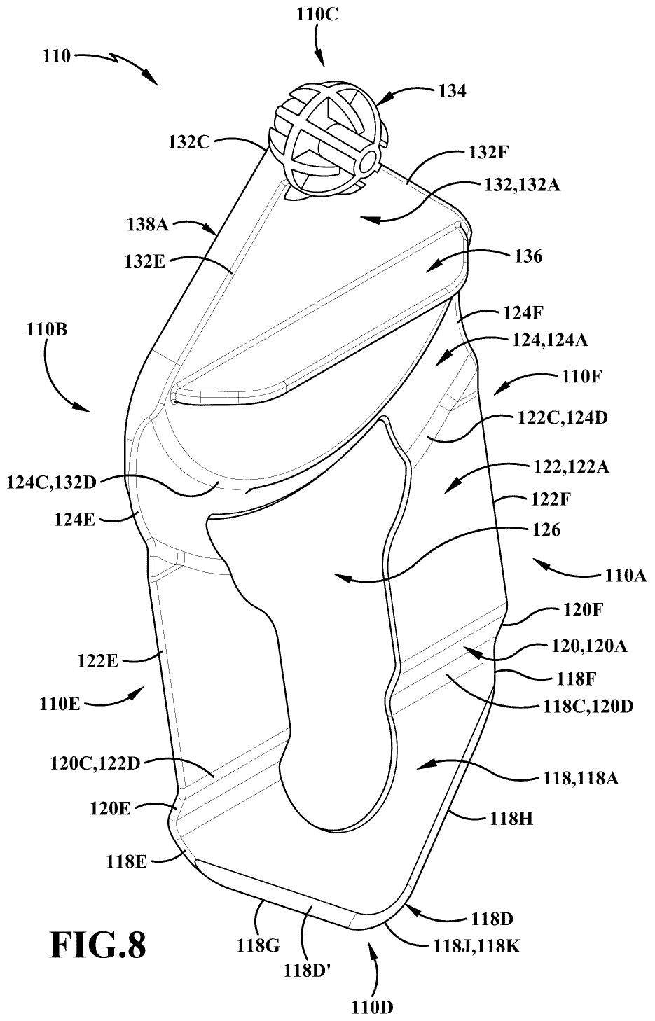

Referring now to FIGS. 8-13, there is shown a second embodiment of a window insert in accordance with an aspect of the present disclosure, generally indicated at 110. Window insert 110 is substantially identical in function to window insert 10 but differs in some structural elements relative to window insert 10. The differences in the structural components of window insert 110 relative to window insert 10 will be discussed hereafter.

Window insert 110 as illustrated is a unibody design. The window insert is a unibody in that the entire component is integrally extruded, molded, printed, or additively manufactured, removably machined, or formed as a single, unitary, monolithic member. Window insert 110 may be fabricated from a relatively rigid, manmade material. In one example, polymer composite materials may be utilized to form a substantial majority of all of the component parts or elements of window insert 110. The polymer composite materials are integrally formed, molded, printed, or extruded to form window insert 110.

Window insert 110 is configured to withstand typical user handling of placing the window insert 110 between a vehicle window “VW” and door panel “DP” within the gap “G” defined between the weather strip “WS” and door panel “DP” (similar to the engagement of window insert 10 with a vehicle door as illustrated in FIG. 1), then utilizing window insert 110 to hold and support a condiment holder, and of placing and using a condiment container within the condiment holder The materials and construction of window insert 110 are such that window insert 110 is not readily damaged during installation and use.

While it is contemplated that window insert 110 is uniformly and integrally extruded, molded, printed, or otherwise formed, it should be understood that in other instances the components or elements of the window insert 110 may be formed separately and then be suitably assembled. Additionally, it will be understood that window insert 110 may be formed from materials other than polymer composite materials. In another example, the window insert 110 may be formed using a semi-rigid elastomeric material or a rubber material configured to withstand deformation upon impact or bending by the user. Any suitable material is contemplated for use in fabricating window insert 110.

While the components or elements of the window insert 110 are discussed below individually, it is to be clearly understood that the components and their corresponding reference elements are respective components or elements of the unitary window insert 110.

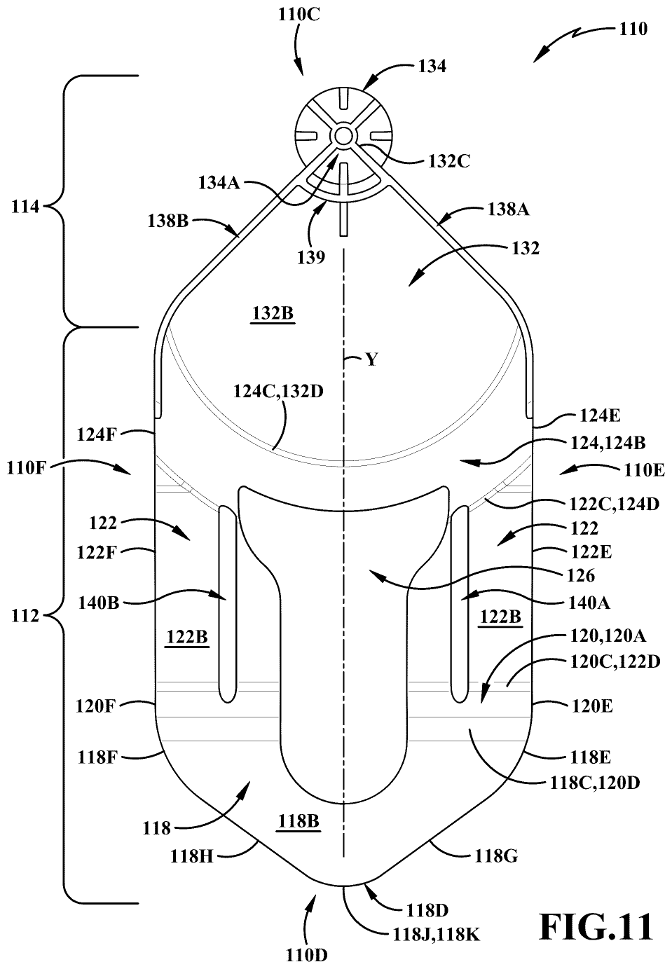

Window insert 110 generally includes a front 110A and a rear 110B opposite one another. Window insert 110 further includes top end 110C and a bottom end 110D opposite one another and defining an uppermost and a lowermost limit of window insert 110 respectively. Window insert 110 further includes a left side 110E and a right side 110F opposite one another. Window insert 110 has an imaginary longitudinal axis “Y” (FIG. 11) which extends from top end 110C to bottom end 110D of window insert 110. Window insert 10 is symmetrical about a midline (not numbered) running along longitudinal axis “Y”.

Window insert 110 generally includes an insertion portion 112 and a support portion 114. Insertion portion 112 extends upwardly from bottom end 110D of window insert 110 and towards top end 110C thereof. Support portion 114 extends between top end 110C and insertion portion 112. Insertion portion 112 is configured to be inserted into the gap “G” (FIG. 1) defined between the door panel “DP” of a vehicle and the weather strip “WS” adjacent the vehicle window “VW” in a similar manner to how insertion portion 12 of the first embodiment window insert 10 is installed for use. Support portion 114 is configured to extend upwardly from insertion portion 112 and out of the gap “G” between the door panel “DP” and weather strip “WS”. Support portion 114 is located adjacent the vehicle window “VW” in a similar manner to how support portion 14 of window insert 10 is located adjacent the vehicle window “VW” as illustrated in FIG. 1.

Referring now to FIGS. 8-12, insertion portion 112 of window insert 110 includes a first region 118, a second region 120, a third region 122, and a fourth region 124. First region 118 comprises a lowermost region of insertion portion 112 of window insert 110. Second region 120 extends upwardly and outwardly from first region 118. Third region 122 extends upwardly and outwardly from second region 120. Fourth region 124 extends upwardly and outwardly from third region 122. Fourth region 124 extends between third region 122 and support portion 114 of window insert 110.

First region 118 has a front surface 118A and a back surface 118B which are opposed to one another. First region 118 has a top 118C which is contiguous with and transitions into second region 120. First region 118 has a left side 118E and a right side 118F which are opposite one another. First region 118 includes an edge 118D extending between left and right sides 118E, 118F and which comprises the bottom end 110D of window insert 110. Edge 118D includes first and second sections 118G, 118H extending downwardly from left and right sides 118E, 118E respectively. First and second sections 118G, 118H are arranged at an angle relative to one another and such that first region 118 is generally V-shaped. Edge 118D further includes a curved section 118J extending between first and second planar sections 118G, 118H. A nadir 118K of curved section 118J defines the bottom end 110D of window insert 110. Edge 118D on front surface 118A is beveled or chamfered. The bevel or chamfer is indicated by reference number 118D′ in FIG. 8.

Second region 120 of insertion portion 112 is generally depicted as being of a rectangular configuration. Second region 120 has a front surface 120A and a back surface 120B which are opposed to one another, a top 120C and a bottom 120D which are opposed to one another, and a left side 120E and a right side 120F which are opposed to one another. The bottom 120D of second region 120 is continuous with the top 118C of first region 118. The left side 120E of second region 120 is generally vertically aligned with the left side 118E of first region 118. Similarly, the right side 120F of second region 120 is generally vertically aligned with the right side 118F of first region 118. Top 120C and bottom 120D are generally parallel with one another and left and right sides 12E, 120F are generally parallel with one another. Second region 120 is located vertically above first region 118. The top 120C of second region 120 is substantially continuous with third region 122.

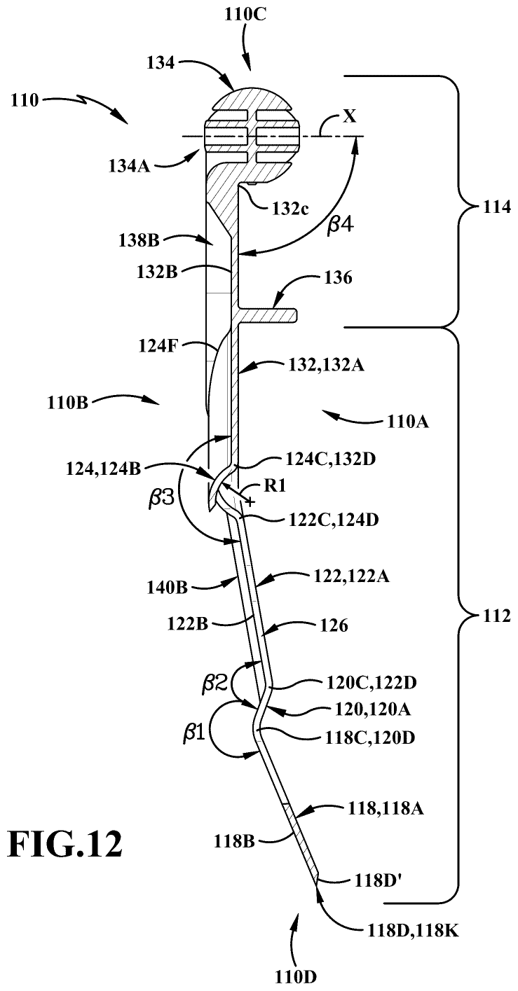

As best seen in FIG. 12, the back surface 120B of second region 120 and back surface 118B of first region 118 are oriented at a first angle “β1” relative to one another. First angle “β1” is greater than 180°. As a consequence, the bottom 120D of second region 120 and top 118C of first region 118 form a first bend in insertion portion 112 that is concave when window insert 110 is viewed from the front.

In one embodiment, first angle “β1” is between 200-240 degrees. More specifically, first angle “β1” is between 210-230 degrees. Most specifically, first angle “β1” is about 223 degrees.

Third region 122 extends upwardly and outwardly from top 120C of second region 120. Third region 122 of insertion portion 112 has a front surface 122A and a back surface 122B which are opposed to one another, a top 122C and a bottom 122D which are opposed to one another, and a left side 122E and a right side 122F which are opposed to one another. The bottom 122D of third region 122 is continuous with the top 120C of second region 120. The left side 122E of third region 122 is vertically aligned with the left side 120E of second region 120. Similarly, right side 122F of third region 122 is vertically aligned with right side 120F of second region 120. Third region 122 is located vertically above second region 120.

As best seen in FIG. 12, the back surface 122B of third region 122 and back surface 120B of second region 120 are oriented at a second angle “β2” relative to one another. Second angle “β2” is less than 180°. As a consequence, the bottom 122D of third region 122 and top 120C of second region 120 form a second bend in insertion portion 112 that is convex when window insert 110 is viewed from the front. In one embodiment, second angle “β2” is between 130-170 degrees. More specifically, second angle “β2” is between 140-160 degrees. Most specifically, second angle “β2” is about 150 degrees.

The bottom 122D of third region 122 is oriented substantially at a right angle relative to left side 122E and right side 122F of third region 122. As a consequence, bottom 122D extends substantially straight across the width of window insert 110 (where the width is measured between the left and right sides of the window insert). Top 122C of third region 122 is arcuate in configuration instead of being substantially straight in configuration. In particular, top 122C is concavely curved such that a vertical length of each of the left side 122E and right side 122F of third region 122 is greater than a vertical length of the third region measured midway between the left side 122E and right side 122F.

As indicated earlier herein, insertion portion 112 further includes an arcuate fourth region 124, generally depicted in FIGS. 8 through 11 as being of a substantially semi-circular configuration. Fourth region 124 has a front surface 124A and a back surface 124B which are opposed to one another, a top 124C and a bottom 124D which are opposed to one another, a left side 124E and a right side 124F which are opposed to one another. The bottom 124D of fourth region 124 is substantially continuous with the top 122C of third region 122. The left side 124E of fourth region 124 is generally vertically aligned with and continuous with the left side 122E of third region 122. Similarly, the right side 124F of fourth region 124 is generally vertically aligned with and continuous with the right side 122F of third region 122. As best seen in FIG. 12, fourth region 124 defines a first radius of curvature “R1”. In one embodiment, the first radius of curvature “R1” is between 0.1-0.3 inches. More specifically, the first radius of curvature “R1” is between 0.15-0.25 inches. Most specifically, the first radius of curvature “R1” is about 0.2 inches.

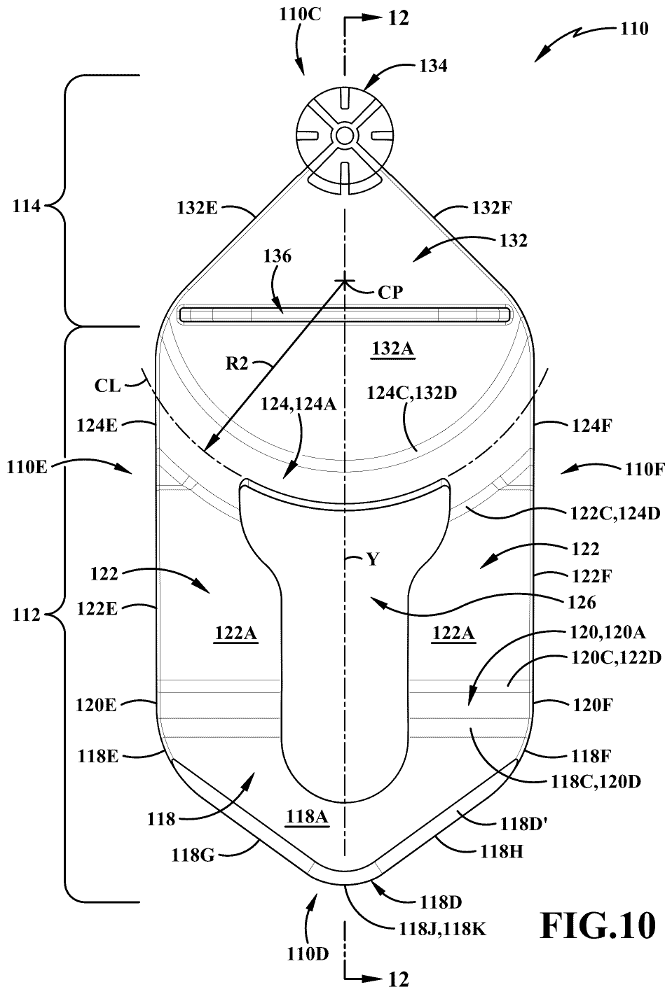

Fourth region 124 is located vertically above third region 122. Each of the top 124C and bottom 124D of fourth region 124 is arcuate in configuration. In particular, the top 124C and bottom 124D are similarly concavely curved and have the same radius of curvature as the top 122C of third region 122. Fourth region 124 defines a centerline “CL” (FIG. 10) vertically equidistant from top 124C and bottom 124D and extending from left side 124E to right side 124F. Centerline “CL” of fourth region 124 defines a second radius of curvature “R2” measured from a center point “CP” of support region 114 (FIG. 10), where the center point “CP” is located along the longitudinal axis “Y” of window insert 110. In one embodiment, the second radius of curvature “R2” is between 0.75-1.75 inches. More specifically, the second radius of curvature “R2” is between 1.0-1.5 inches. Most specifically, the second radius of curvature “R2” is about 1.25 inches.

As best seen in FIG. 12, the back surface 124B of fourth region 124 and the back surface 122B of third region 122 are contiguous with one another. As a consequence, the bottom 124D of fourth region 124 and the top 122C of third region 122 form a third bend in insertion portion 112 that is convex when insert 110 is viewed from the front.

As is particularly evident from FIG. 8, first region 118, second region 120, third region 122, and fourth region 124 are interrupted by aperture 126. Aperture 126 extends vertically through a central portion of first, second, third, and fourth regions 118, 120, 122, 124 from the front surfaces 118A, 120A, 122A, 124A through to the back surfaces 118B, 120B, 122B, 124B thereof. As illustrated in FIG. 11, aperture 126 is generally Y-shaped, being of a greater width in fourth region 124 than in third region 122, second region 120, and first region 118. It will be understood, however, that aperture 126 may be of any other desired shape and size which ensures that window insert 110 is of sufficient strength to secure and support a condiment holder and associated condiment container thereto. In other embodiments (not shown herein), aperture 126 may be entirely omitted from window insert 110.

It will be understood that although second, third, and fourth regions 120, 122, 124 are illustrated herein as being generally rectangular or semi-circular in configuration, these regions may, alternatively, be of any desired shapes and angles relative to one another that is suitable for the insertion portion 112 to be inserted between the weather strip “WS” (see FIG. 1) and door panel “DP” of the vehicle door within the gap “G” defined between the weather strip “WS” and door panel “DP”.

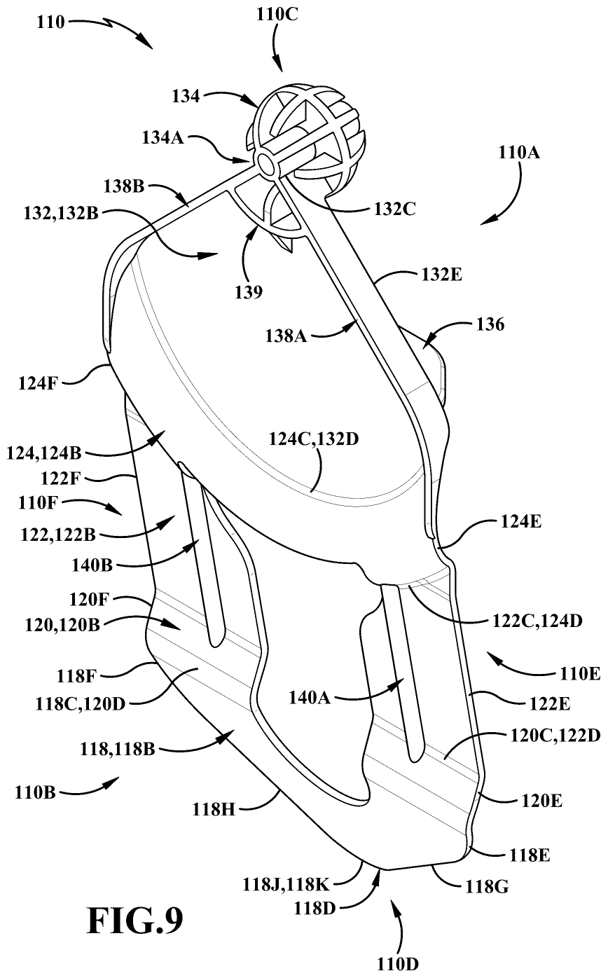

As best seen in FIGS. 9 and 11, a pair of strengthening ribs 140A, 140B is provided on insertion portion 112 of window insert 110. Each rib of the pair of strengthening ribs 140A, 140B forms a vertically-oriented, convex projection which extends outwardly from back surfaces 120B, 122B, 124B of second, third, and fourth regions 120, 122, 124 of insertion portion 112. Ribs 140A, 140B are arranged generally parallel to one another and extend longitudinally along the rear 110B of window insert 110. Each rib of the pair of strengthening ribs 140A, 140B is configured to strengthen insertion portion 112 and to prevent bending or misshaping of the insertion portion 112 during use of window insert 110 as will be described later herein. It will be understood that more than two strengthening ribs or fewer than two strengthening ribs may be provided on window insert 110.

Referring still to FIGS. 8-11, support portion 114 of window insert 110 includes a panel 132 which extends outwardly from the top 124C of fourth region 124. Panel 132, as illustrated, is generally configured as being of an inverted V-shape with an apex of the V-shape being located proximate a top 110C of window insert 110.

Panel 132 has a front surface 132A and a back surface 132B which are opposed to one another, a top 132C (FIG. 11) and a bottom 132D which are opposed to one another, a left side 132E and a right side 132F. Top 132C comprises the apex of the V-shaped panel 132. Bottom 132D of panel 132 is substantially continuous with top 124C of fourth region 124 of insertion portion 112 and is arcuately curved in a substantially identical manner to top 124C of fourth region 124.

As best seen in FIG. 12, back surface 132B of panel 132 and back surface 124B of fourth region 124 are contiguous with one another. Consequently, a fourth bend is formed in insert 110 along the top 124C of fourth region 124 and bottom 132D of panel 132. The fourth bend is convex when insert 110 is viewed from the front. Also as best seen in FIG. 12, back surface 132B of panel 132 and back surface 122B of third region 122 are oriented at a third angle “β3” relative to one another. In one embodiment, third angle “β3” is between 170-210 degrees. More specifically, third angle “β3” is between 180-200 degrees. Most specifically, third angle “β3” is about 190 degrees.

Left side 132E and right side 132F of panel 132 are arranged at an angle relative to one another so that panel 132 is wider proximate bottom 132D and tapers moving in a direction towards the apex of the V-shape, i.e., towards top 132C. Left side 132E extends outwardly and upwardly from a first end (not numbered) of bottom 132D at a first angle and right side 132F extends outwardly from a second end (not numbered) of bottom 132D at a second angle. First angle and second angle are substantially equal to one another. Left and right sides 132E, 132F meet at the apex, i.e., top 132A.

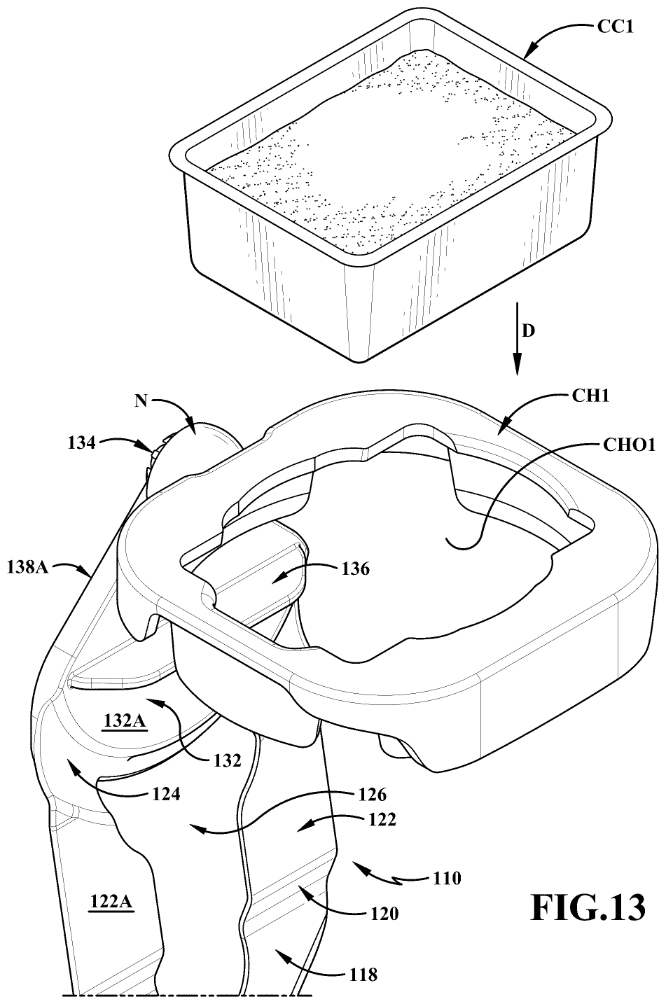

Panel 132 further includes a plurality of reinforcement gussets 139 extending outwardly from back side 132B of panel 132 and between the left and right sides 132E, 132F. The plurality of reinforcement gussets 139 are configured to prevent bending or misshaping of window insert 110 when window insert 110 is used to support a condiment holder and condiment container. An attachment member 134 is provided at top 132C of panel 132. Attachment member 134 comprises a generally spherical-shaped ball, which is configured for engagement with a ball-shaped socket defined in a neck “N” (FIG. 12) of a complementary condiment holder “CH1” (FIG. 13) in order to secure the condiment holder “CH1” to the window insert 110. Condiment holder “CH1”, as illustrated in FIG. 13, is substantially identical to the condiment holder shown and described in U.S. Pat. No. 10,967,776 (Koury et al.) entitled “Condiment Holder”; U.S. Pat. No. 11,518,287 (Moujaes et al.) entitled “Rotatable Condiment Holder”; and U.S. patent application Ser. No. 17/992,991 (Koury et al.) entitled “Rotatable Condiment Holder”; the entire disclosures of which are incorporated herein by reference.

Attachment member 134 may be considered a receiver portion configured to engagingly receive and support condiment holder “CH1” and thereby a condiment container “CC1” to window insert 110. The ball-shaped attachment member 134 generally includes a plurality of surfaces and ridges (not numbered) that facilitate the connection between attachment member 134 and a ball-shaped socket defined in the neck “N” of condiment holder ‘CH1”.

Attachment member 134 has a center point 134A (FIGS. 10 and 12) and an axis “X” defined therethrough. As best seen in FIG. 12, the axis “X” extending through the center point 134A of attachment member 134 and front surface 132A of panel 132 are oriented at a fourth angle “β4” relative to one another. In one embodiment, fourth angle “β4” is between 70-110 degrees. More specifically, fourth angle “β4” is between 80-100 degrees. Most specifically, fourth angle “β4” is about 90 degrees.

Although not illustrated herein, it will be understood that the neck “N” of condiment holder “CH1” (FIG. 13) defines a generally spherical socket which is complementary in size and shape to the ball-shaped attachment member 134. Attachment member 134 is received within the socket defined by the neck “N” in such a way as to form a ball and socket type joint which enables rotation of the condiment holder “CH1” relative to the window insert 110. The ability to rotate the condiment holder “CH1” relative to the window insert 110 enables a user to set the condiment holder “CH1” at a desired orientation relative to the window insert 110 in order to permit easier access to a condiment received in the condiment container “CC1” engaged in condiment holder “CH1”.

It will be understood that although attachment member 134 is illustrated herein as being generally spherical in configuration, attachment member 134 may, alternatively, be of any desired shape suitable to be used to secure a condiment holder to the window insert 110. For example, instead of the spherical ball-shaped attachment member shown in FIGS. 8-13, the attachment member provided on window insert 110 may comprise a horizontally-oriented flange which extends outwardly from the support portion 114 and is suitable for engagement with a condiment holder “CH” such as that shown in FIG. 1.

Support portion 114 further includes a shelf 136 extending outwardly from panel 132. Specifically, shelf 136 extends outwardly from front surface 132A of panel 132 and is oriented generally at ninety degrees to the front surface 132A of window insert 110. Shelf 136 is of a shape and size sufficient to rest upon a portion of the door panel “DP” of the vehicle door when the window insert 110 is installed in the gap “G” (FIG. 1) so as to prevent window insert 110 from falling downwardly into the gap “G” between the weather strip “WS” and door panel “DP” of the vehicle door.

As best seen in FIG. 10, window insert 110 further includes a first projection 138A extending outwardly for a distance beyond back surface 132B of panel 132 and back surface 124B of fourth region 124 at the left sides 132E, 124E respectively. Window insert 110 also includes a second projection 138B extending outwardly for a distance beyond back surface 132B of panel 132 and back surface 124B of fourth region 124 at the right sides 132F, 124F respectively. First and second projections 138A, 138B meet at the center 134A of attachment member 134.

Shelf 136 forms a limiter region (not numbered). The limiter region is configured to be received within the gap “G” defined between the weather strip “WS” and door panel “DP” and prevent the window insert 10 from falling into the door. Additionally, first projection 138A and second projection 138B may also together with shelf 136 form the limiter region.

The use of window insert 110 will now be described with reference particularly to FIG. 13. It will be understood that the insertion portion 112 of insert 110 may be inserted into the gap defined between weather strip “WS” and door panel “DP” before engagement of condiment holder “CH1” with insert 110 or after engagement of condiment holder “CH1” with insert 110. The insertion portion 112 may be pushed downwardly into the gap until the shelf 136 and/or the first and second projections 138B limit the downward travel of the window insert 110. Condiment holder “CH1” is engaged with window insert 110 by press-fitting the attachment member 134 into the socket defined by the neck “N” of the condiment holder “CH1”.

At this point, condiment holder “CH1” is ready for engagement of condiment container “CC1” therewith. In order to engage condiment container “CC1” with condiment holder “CH1”, the condiment container “CC1” is moved in the direction of arrow “D” (FIG. 13) and is frictionally engaged in the condiment holder opening “CHO1” defined by condiment holder “CH1”. Once condiment container “CC1” is engaged in the aperture defined by condiment holder “CH1”, the window insert 110 is then in condition for a user to easily access the condiment within condiment container “CC1”.

When it is no longer desired to use window insert 110, the user will simply grasp support section 114 and slide the insertion portion 112 upwardly and out from the gap defined between weather strip “WS” and door panel “CP”. The window insert 110 is contemplated to be able to be used more than once.

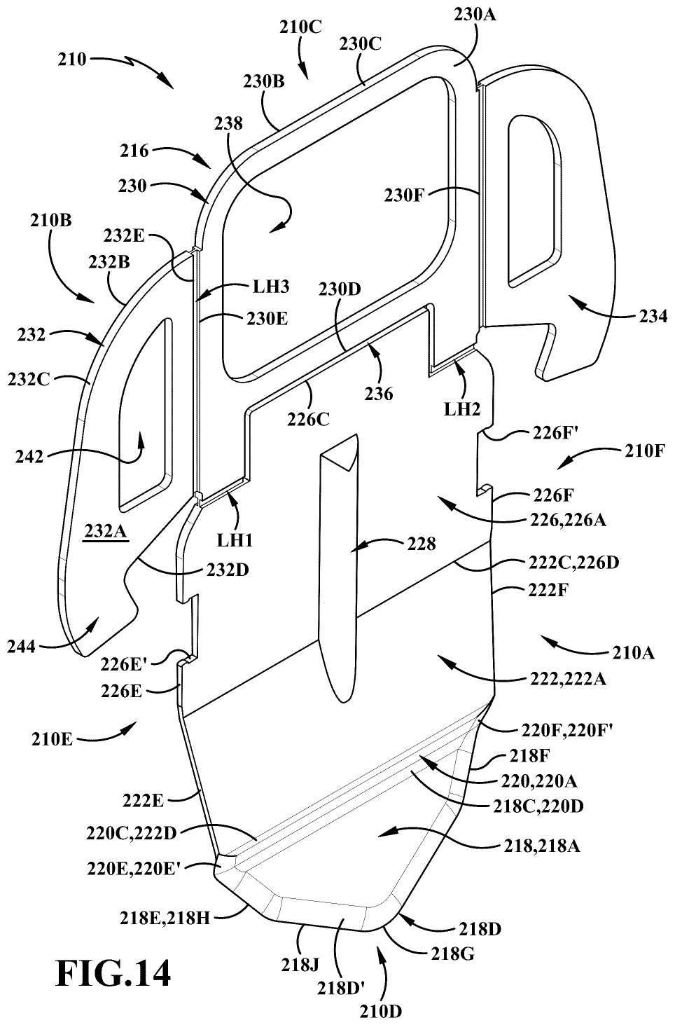

Referring now to FIGS. 14-18, there is shown a third embodiment of window insert in accordance with an aspect of the present disclosure, generally indicated at 210. Window insert 120 is similar in function to window inserts 10, 110 but differs in structure relative to window inserts 10 and 110. The differences in the window insert 210 relative to window inserts 10, 110 will be discussed hereafter.

Window insert 210 is generally made of a material that enables the device to be disposable after a single use or after relatively few uses relative to window inserts 10, 110. (Window inserts 10, 110 are fabricated from materials which make the inserts suitable for multiple uses if that is desired.) In one embodiment, window insert 210 may be made of cardboard or other paper products or any other materials suitable to provide window insert 210 with sufficient structural stability for use with a condiment holder but which are economically and/or environmentally friendly for disposing of the window insert 210 after a single use. Preferably, window insert 210 is fabricated from a recyclable material.

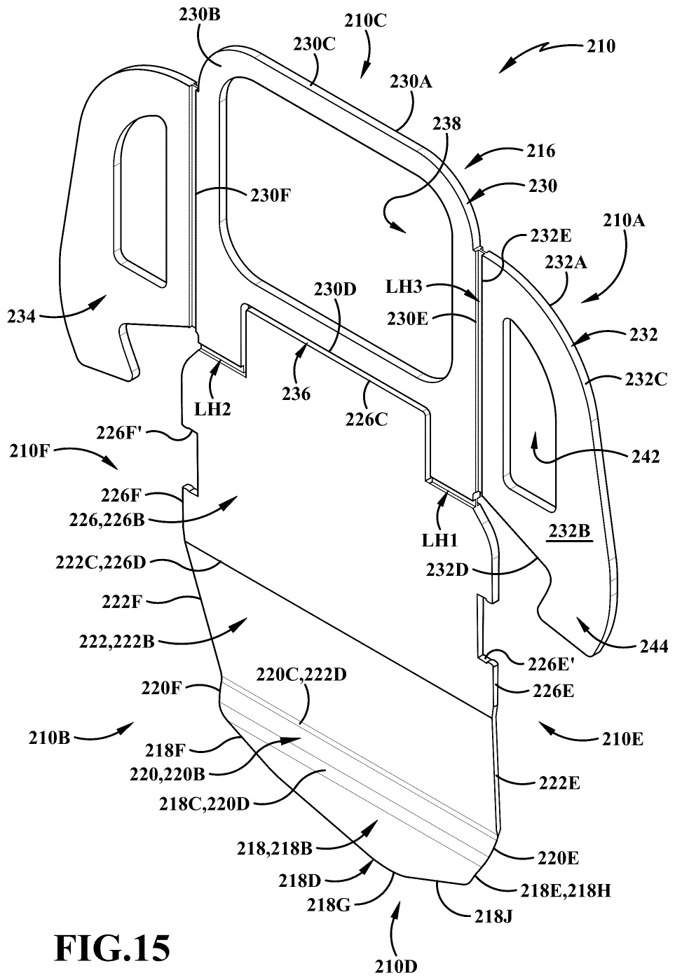

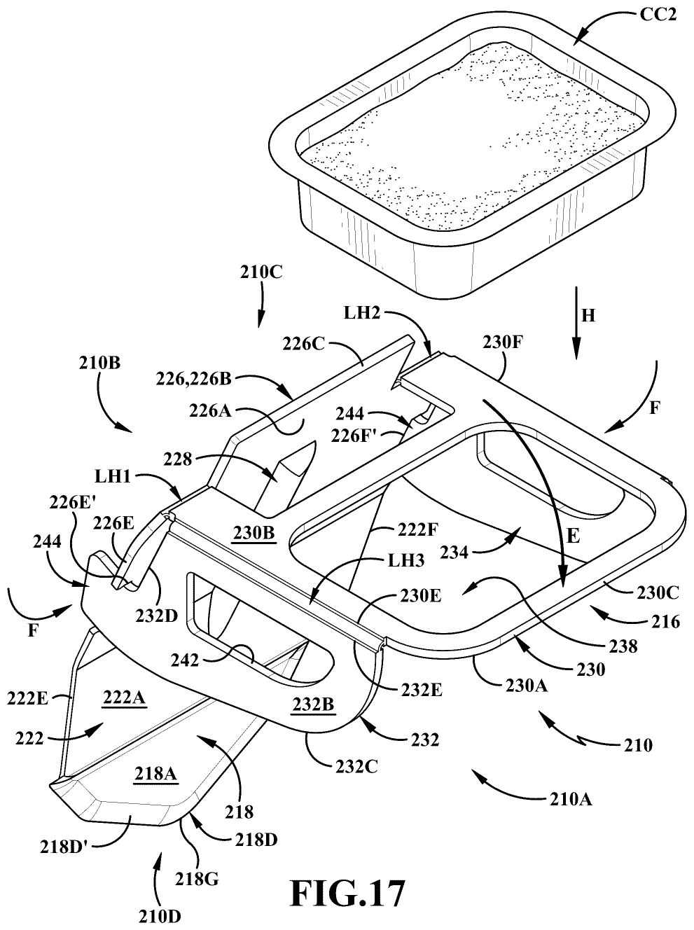

FIGS. 14 and 15 show a blank of window insert 210 and FIG. 17 shows how the blank is folded into a format suitable to enable window insert 210 to be inserted into a gap “G” between a door panel “DP” and weather strip “WS” adjacent a vehicle window and then used to support a condiment container “CC2” therein as is shown in FIG. 17.

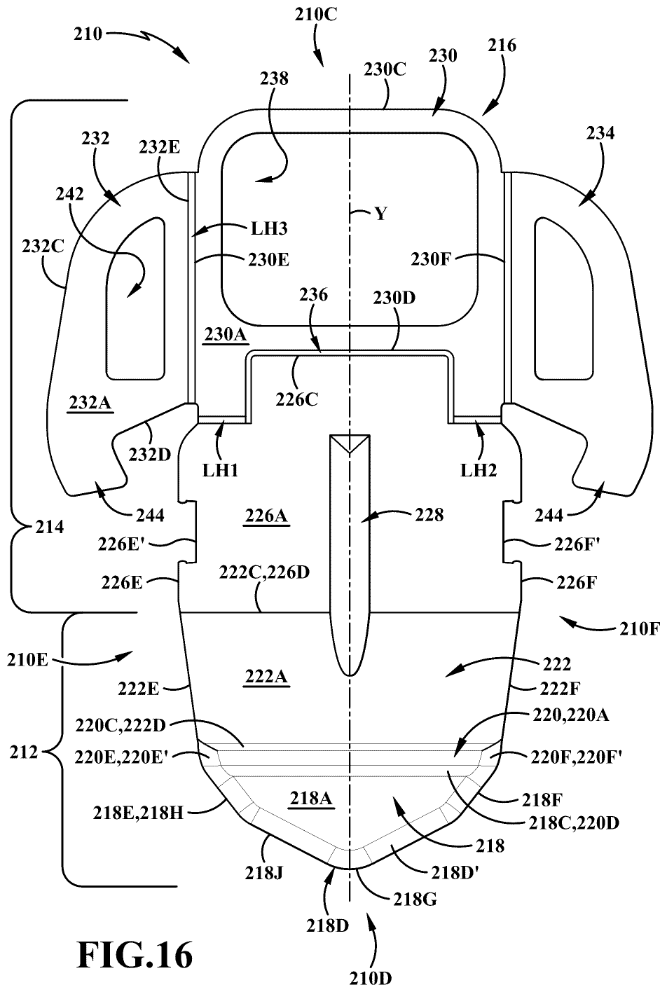

Window insert 210 generally includes a front 210A and a rear 210B opposite one another. Window insert 210 further includes a top end 210C and a bottom end 210D opposite one another and defining an uppermost and a lowermost limit of window insert 210 respectively. Window insert 210 further includes a left side 210E and a right side 210F opposite one another. Window insert 210 has an imaginary longitudinal axis “Y” (FIG. 16) which extends from top end 210C to bottom end 210D of window insert 210. Window insert 210 is symmetrical about a midline (not numbered) running along longitudinal axis “Y”.

Window insert 110 generally includes an insertion portion 212 and a support portion 214. Insertion portion 212 extends upwardly from bottom end 210D towards top end 210C and comprises that part of window insert 110 which will be inserted into the gap defined between the weather strip “WS” (FIG. 1) and door panel “DP” of a vehicle door. Support portion 214 extends between insertion portion 212 and top end 210C and comprises that part of window insert 110 which will extend upwardly out of the gap between the weather strip “WS” and the door panel “DP”. Support portion 214 includes a condiment holder portion 216 suitable for engagement of a condiment holder “CH” therewith.

Referring now to FIGS. 14-16, and 17, insertion portion 212 of window insert 210 includes a first region 218, a second region 220, and a third region 222. First region 218 originates at bottom end 210D of window insert 210 and comprises a lowermost region of window insert 210. Second region 220 extends upwardly and outwardly from first region 218. Third region 222 extends between second region 220 and support portion 214 of window insert 210.

First region 218 has a front surface 218A and a back surface 218B which are opposed to one another. First region 218 has a top 218C which is contiguous with and transitions into second region 220. Front and back surface 218A, 218B meet along an edge 218D which comprises the bottom end 210D of window insert 210.

Edge 218D is generally V-shaped when window insert 210 is viewed from the front as in FIG. 16. Edge 218D includes a left section 218E and a right section 218F which are opposed to one another. Edge 218D includes an arcuate section 218G extending between left and right section 218E, 218F. Left and right section 218E, 218F are mirror imagines of one another and it will be understood the following description of left section 218E will equally apply to right section 218F. Left section 218E includes a first straight section 218H extending downwardly from top 218C of first region and a second straight section 218J extending between first straight section 218H and arcuate section 218G. Edge 218D on front surface 118A is beveled or chamfered. The bevel or chamfer is indicated by reference number 218D′ in FIGS. 14 and 16.

Second region 220 of insertion portion 212 is generally of a rectangular configuration and comprises a front surface 220A and a back surface 220B which are opposed to one another, a top 220C and a bottom 220D which are opposed to one another, and a left side 220E and a right side 220F which are opposed to one another. Left side 220E on front surface 220A is beveled or chamfered, which is indicated by reference number 220E′ in FIG. 14. Similarly, right side 220F on front surface 220A is beveled or chamfered, which is indicated by reference number 220F′ in FIG. 14. The bottom 220D of second region 220 is continuous with top 218C of first region 218. Left side 220E is continuous with left section 218E of edge 218D of first region 218. Similarly, right side 220F is continuous with right section 218F of edge 218D of first region 218. Top 220C and bottom 220D are generally parallel to one another and left and right side 220E, 220F are generally parallel to one another. Second region 220 is located vertically above first region 218.

As best seen in FIGS. 13, 15, and 18, the back surface 220B of second region 220 and the back surface 218B of first region 218 are oriented at a first angle “ε1” relative to one another. First angle “ε1” is greater than 180°. A first bend is formed between the first and second regions 218, 220. The first bend extends along top 218C and bottom 220D of first and second regions 218, 220, respectively. The first bend is concave when window insert 210 is viewed from the front. In one embodiment, first angle “ε1” is between 210-240 degrees. More specifically, first angle “ε1” is between 220-230 degrees. Most specifically, first angle “ε1” is about 223 degrees.

As indicated earlier herein, insertion portion 212 further includes third region 222, generally depicted herein as being of a rectangular configuration. Third region 222 has a front surface 222A and a back surface 222B which are opposed to one another, a top 222C and a bottom 222D which are opposed to one another, and a left side 222E and a right side 222F which are opposed to one another. Bottom 222D of third region 2222 is continuous with top 220C of second region 220. Left side 222E is vertically aligned with and continuous with left side 220E of second region 220. Similarly, right side 222F is vertically aligned with and continuous with right side 220F of second region 220. Top 222C and bottom 222D are generally parallel with one another and left and right sides 222E, 222F are generally parallel with one another. Third region 222 is located vertically above second region 220.

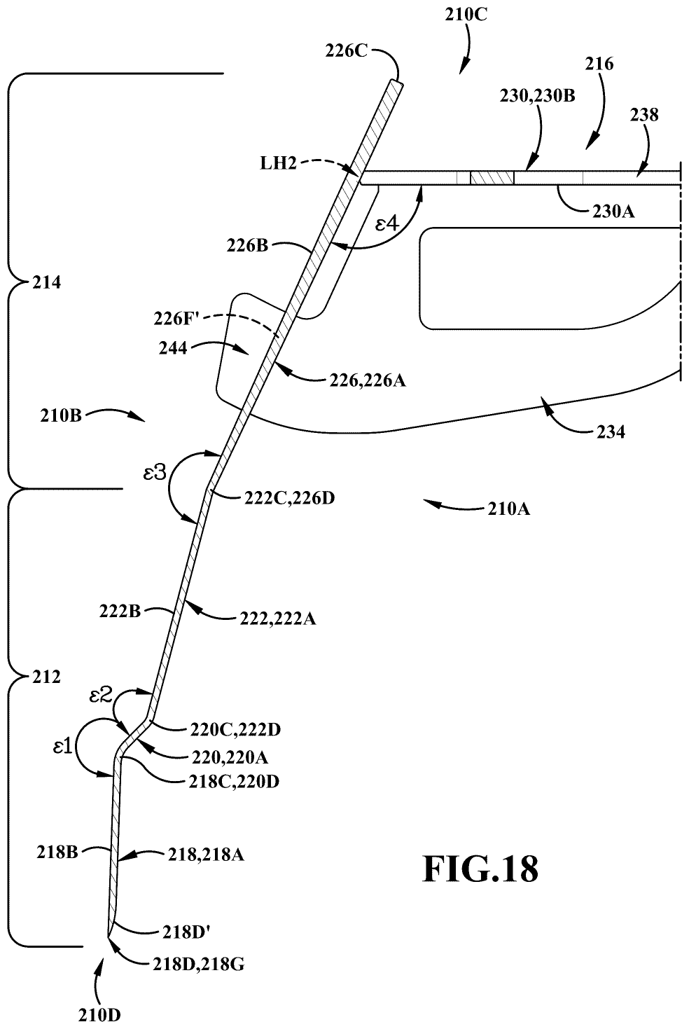

As best seen in FIG. 18, the back surface 222B of third region 222 and back surface 220B of second region 220 are oriented at a second angle “ε2” relative to one another. Second angle “ε2” is less than 180°. As a consequence, the bottom 222D of third region 222 and top 220C of second region 220 form a second bend in insertion portion 212 that is convex when window insert 210 is viewed from the front. In one embodiment, second angle “ε2” is between 130-170 degrees. More specifically, second angle “ε2” is between 140-160 degrees. Most specifically, second angle “ε2” is about 150 degrees.

It will be understood that although second region 220 and third region 222, are illustrated herein as being generally rectangular in configuration, these regions may, alternatively, be of any desired shape suitable for window insert 210 to be inserted in between the weather strip “WS” and door panel “DP” of the vehicle door.

Support portion 214 includes a panel 226 extending upwardly and outwardly from third region 222 of insertion portion 212. Panel 226 has a front surface 226A and a back surface 226B which are opposed to one another, a top 226C (FIG. 18) and a bottom 226D which are opposed to one another, and a left side 226E and a right side 226F which are opposed to one another. Panel 226 is located vertically above third region 222 of insertion portion 212.

As best seen in FIG. 18, back surface 226B of panel 26 is arranged at a third angle “ε3” relative to back surface 222B of third region 222 of insertion portion 212. The third angle “ε3” is greater than 180°. Consequently, a third bend is formed in window insert 210 along the top 222C of third region 222 and bottom 226D of panel 26. The fourth bend is concave when window insert 210 is viewed from the front. In one embodiment, third angle “ε3” is between 180-210 degrees. More specifically, third angle “ε3” is between 185-200 degrees. Most specifically, third angle “ε3” is about 189 degrees.

Panel 226 may be of increased thickness as measured between front surface 226A and back surface 226B moving upwardly in a direction from bottom 226D of panel 226 and toward top 226C thereof. Panel 226 further defines a first inset 226E′ in left side 226E and a second inset 226F′ in right side 226F. First and second insets 226E′, 226F′ are substantially identical to one another other than in orientation. Each inset comprises a U-shaped recess formed in the associate side of panel 226.

As best seen in FIGS. 14 and 16, a strengthening rib 228 projects outwardly from front surface 222A of third region 222 and front surface 226A of panel 226. Rib 228 is located generally along the midline of window insert 210 and originates approximately midway between top 222C and bottom 222D of third region 222. When window insert 210 is viewed from the front, the lowermost end of the rib 228 is generally a rounded V-shape in configuration. Strengthening rib 228 is configured to prevent bending or misshaping of window insert 210 when the insert is used to support a condiment container “CC2” therein as is shown in FIG. 17.

Condiment holder portion 216 extends outwardly from top 226C of panel 226. Condiment holder portion 216 includes a receiver portion 230 and a first wing region 232 and a second wing region 234 which extend laterally outwardly from opposite sides of receiver portion 230. As shown in FIG. 14, receiver portion 230 comprises an uppermost region of the blank used to form window insert 210. First and second wing regions 232, 234 extend horizontally outwardly from receiver portion 230 in opposite directions from one another.

Receiver portion 230 has a front surface 230A a back surface 230B which are opposed to one another, a top 230C and a bottom 230D which are opposed to one another, a left side 238E and a right side 238F which are opposed to one another. Receiver portion 230 is foldable relative to panel 226 along a pair of laterally spaced apart living hinges “LH1” and “LH2” which are horizontally aligned with one another. An inverted U-shaped cut line “C1” extends upwardly into the receiver portion 230 and between the living hinges “LH1” and “LH2”. As a result, when receiver portion 230 is folded relative to panel 226 along living hinges “LH1” and “LH2”, as is indicated by arrow “E” in FIG. 16, a U-shaped section of panel 226 extends for a distance above back surface 230B of receiver portion 230. A U-shaped aperture 236 is defined between front surface 230A and back surface 230B of receiver portion 230. Bottom 230D of receiver portion 230 is substantially continuous with top 226C of panel 226.

Receiver portion 230 defines an aperture 238 extending therethrough from front surface 230A to back surface 230B. Aperture 238 is adapted to receive a condiment container therein which may be supplied to a consumer by a fast food restaurant. Aperture 238 is illustrated herein as being generally rectangular in configuration and is therefore suitable for receiving a generally rectangular condiment container therein. It will be understood, however, that the aperture 238 may be of any other suitable size and shape to receive a condiment container therein that is differently shaped from a rectangular condiment container. For example, the aperture in receiver portion 230 may be configured to be generally circular in shape in order to receive a generally circular condiment container therein. In other instances, the aperture may be of a more complex configuration which enables more than one shape of condiment container to be received therein. For example, the aperture may be shaped similar to the aperture “CHO” shown in condiment holder “CH” in FIG. 1. In this latter instance, the receiver portion 230 of window insert 210 may be capable of retaining any of four or five differently-shaped condiment containers therein.

Referring still to FIGS. 14-16, first wing region 232 and second wing region 234 of support portion 214 are substantially identical to one another except for their orientation relative to receiver portion 230. It will be understood that the following description of first wing region 232 will equally apply to second wing region 234.

First wing region 232 has a front surface 232A and a back surface 232B which are opposed to one another. First wing region 232 has an outermost edge 232C which is curved and defines the uppermost and leftmost points of first wing region 232. First wing region 232 further has a bottom 232D. Edge 232C and bottom 232D are connected to one another via a side 232E extending therebetween. Side 232E of first wing region 232 is connected to the left side 238E of receiver portion 230 via a living hinge “LH3”. The living hinge “LH3” is thinner than a thickness of the first wing region 232 and the receiver portion 230 as measured between the front surface and back surface thereof. The thinner living hinge “LH3” makes it possible for the first wing region 232 to be foldable relative to the receiver portion 230.

First wing region 232 defines a hole 242 therein where the hole 242 extends through at least a portion of the first wing region 232 from front surface 232A to back surface 232B thereof. First wing region 232 further defines a tab 256 extending outwardly from edge 232C and bottom 232D. Tab 256 is configured to be utilized to secure first wing region 232 and thereby condiment holder portion 216 to support portion 214, as will be later described herein.

The use of window insert 210 will now be described with reference particularly to FIGS. 17 and 18. Window insert 210 is folded and assembled into a use configuration from the blank shown in FIGS. 14 and 15. In particular, the blank is moved to the use configuration by folding the receiver portion 230 along the living hinges “LH1” and “LH2” in the direction indicated by arrow “E” (FIG. 17) and folding first and second wing regions 232, 234 along living hinge “LH3” in the direction indicated by arrows “F”. First and second wing regions 232, 234 are secured to the panel 226 of support portion 214 by inserting the tabs 256 on the wings 232, 234 into the first and second insets 226E′, 226F′ on panel 226, respectively. The tabs 256 are shaped and sized to be frictionally engaged in the insets 226E′, 226F′ and to project a short distance outwardly beyond back surface 232B of panel 226 when engaged into the tabs 256.

As best seen in FIG. 18, once the window insert 210 is folded and assembled into the use configuration, a fourth angle “ε4” is defined between the front surface 226A of panel 226 and front surface 230A of receiver portion 230. In one embodiment, fourth angle “ε4” is between 95-135 degrees. More specifically, fourth angle “ε4” is between 105-125 degrees. Most specifically, fourth angle “ε4” is about 115 degrees.

It will be understood that after construction of window insert 210, (i.e., folding and assembly of the blank into the use configuration), insertion portion 212 is able to be inserted into the gap defined between weather strip “WS” and door panel “DP” of a vehicle door in a similar manner to how insert 10 is shown engaged in the gap in FIG. 1. After insertion of window insert 210 into the gap between weather strip “WS” and door panel “DP”, window insert 210 is ready for use. A user is able to place a condiment container “CC2” (FIG. 16) into the aperture 238 defined in receiver portion 232 by lowering the condiment container “CC2” in the direction of arrow “H” (FIG. 17) and thereby easily access condiment held by the condiment container.

First wing region 232 and second wing region 234 together form a limiter region on window insert 210. The limiter region is configured to prevent the insertion portion 212 from dropping downwardly into the gap “G” defined between the weather strip “WS” and door panel “DP” and thereby prevents the window insert 10 from falling into the door. The first wing region 232 and second wing region 234 may rest upon the upper end of the door panel “DP”. Additionally, strengthening rib 228 may form a part of the limiter region together with first wing region 232 and second wing region 234 which restricts downward movement of the window insert 210 into the gap. Once the user has finishing using window insert 210 to support condiment container “CC2”, the window insert 210 is withdrawn from the gap “G” and may be thrown away or be recycled.

It will be understood that while it is contemplated that window insert 210 will be disposable after a single use and is contemplated to be fabricated from recyclable materials, in other instances the window insert 210 may be fabricated from any suitable material which is able to be reused more than once. In particular, the window insert 210 may be fabricated from a washable, resilient material which is able to be moved from the use configuration shown in FIG. 17 back to the blank configuration shown in FIG. 14 so that the insert 210 may be readily stored in a substantially flat configuration in the vehicle for subsequent use.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the rib being half circle shaped, the rib 36 can be semi-circular, triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A window insert for retaining a condiment container, the window insert comprising:
an insertion portion adapted to be inserted into a gap defined between a door panel and a window of a vehicle;
a support portion extending outwardly from the insertion portion, said support portion being adapted to be located adjacent the window when the insertion portion is inserted into the gap; and
a receiver portion provided on the support portion, said receiver portion being adapted to support a condiment container.

2. The window insert of claim 1, further comprising:
a front surface and a rear surface opposite one another; and
a limiter region extending outwardly from the front surface for a distance.

3. The window insert of claim 2, wherein the limiter region is located a distance vertically below the receiver portion.

4. The window insert of claim 1, wherein the insertion portion comprises:
a first region originating at a bottom of the window insert;
a second region extending upwardly from the first region; and
wherein a back surface of the second region is arranged at a first angle relative to a back surface of the first region.

5. The window insert of claim 4, wherein the first angle is less than 180 degrees.

6. The window insert of claim 4, wherein the first region tapers in a direction from the second region to the bottom of the window insert.

7. The window insert of claim 4, wherein the insertion portion further comprises:
a third region extending upwardly from the second region; and
wherein a back surface of the third region is arranged at a second angle relative to the back surface of the second region.

8. The window insert of claim 7, wherein the second angle is greater than 180 degrees.

9. The window insert of claim 7, wherein the insertion portion further comprises:
a fourth region extending between the support portion and the third region of the insertion portion; and
wherein a back surface of the fourth region is arranged at a third angle relative to the back surface of the third region.

10. The window insert of claim 9, wherein the third angle is greater than 180 degrees.

11. The window insert of claim 1, further comprising:
an aperture defined in the insertion portion; and
wherein the aperture extends between a front and a back surface of the window insert.

12. The window insert of claim 1, further comprising:
at least one strengthening rib provided on the insertion portion; and
wherein the at least one strengthening rib is formed on a back surface of the window insert.

13. The window insert of claim 1, further comprising:
at least one strengthening rib provided on a front surface of the window insert; and
wherein the at least one strengthening rib extends between a part of the insertion portion and a part of the support portion.

14. The window insert of claim 1, wherein the support portion comprises:
a front surface and a back surface opposite one another;
a perimeter wall extending outwardly beyond the front surface; and
wherein the receiver portion is defined by a portion of the perimeter wall.

15. The window insert of claim 14, wherein the perimeter wall comprises:
a first planar region and a second planar region opposed to one another; and
wherein the first planar region and the second planar region taper in depth moving in a direction from a top of the window insert toward the insertion portion.

16. The window insert of claim 15, wherein the first and second planar region comprise a limiter region of the window insert.

17. The window insert of claim 1, wherein the support portion extends upwardly from the insertion portion and is an inverted V-shape.

18. The window insert of claim 17, wherein the support portion comprises:
a top end and a bottom end opposite one another;
a left side and a right side extending between the top and bottom ends; and
wherein the bottom end is arcuate in shape.

19. The window insert of claim 1, further comprising:
a shelf extending beyond a front surface of the support portion; and
wherein the shelf comprises a limiter region of the window insert.

20. The window insert of claim 1, wherein the receiver portion is bendable relative to a lowermost section of the support portion.

21. The window insert of claim 20, further comprising:
a first wing and a second wing extending beyond a first side and a second side of the receiver portion respectively.

22. The window insert of claim 21, wherein each one of the first and second wings is foldable relative to the receiver portion.

23. The window insert of claim 22, further comprising:
a tab extending outwardly from each of the first and second wings;
an insert defined in the lowermost section of the support portion; and
wherein the tab is frictionally engaged within the insert when the first and second wings are folded relative to the receiver portion.

24. The window insert of claim 1, further comprising:
an aperture define in the receiver portion;
wherein the aperture extends between a front surface and a back surface of the receiver portion; and
wherein the aperture is adapted to receive the condiment container therein.

25. The window insert of claim 24, wherein the aperture is complementary to the condiment container to be received therein.

26. A method for presenting condiments for use while seated in a vehicle, said method comprising:
obtaining a condiment container holding a volume of condiment therein;
obtaining a window insert;
inserting an insertion portion of the window insert into a gap between a vehicle door panel and a weather strip of a vehicle window on a vehicle door;
extending a support portion of the window insert outwardly from the gap;
positioning the support portion adjacent to the vehicle window; and
engaging the condiment container with a receiver portion of the support portion of the window insert.

27. The method of claim 26, wherein engaging the condiment container with the receiver portion comprises:
providing a condiment holder;
fastening the condiment holder to the receiver portion; and
inserting the condiment container into the condiment holder.

28. The method of claim 27, wherein inserting the condiment container into the condiment holder further comprising:
inserting the condiment container into an aperture defined by the condiment holder.

29. The method of claim 27, wherein engaging the condiment container with the receiver portion further comprising:
inserting the condiment container into an aperture defined by the receiver portion.
